(19) United States
(12) Patent Application Publication
(10) Pub. No.: US 2012/0037475 A1
(43) Pub. Date: Feb. 16, 2012

(54) SUBSTRATE INVERTING SYSTEM

(75) Inventors: Andrea Baccini, Treviso (IT); Marco Galiazzo, Padova (pd) (IT)

(73) Assignee: APPLIED MATERIALS, INC., Santa Clara, CA (US)

(21) Appl. No.: 13/202,956

(22) PCT Filed: May 25, 2009
(86) PCT No.: PCT/EP09/56328

§ 371 Date: Oct. 31, 2011

(30) Foreign Application Priority Data
Feb. 23, 2009 (IT) UD2009A000041

(51) Int. Cl. B65G 47/252; B65G 49/06

(52) U.S. Cl. 198/379; 198/373

(57) ABSTRACT

A method and apparatus for performing high-speed substrate inverting to facilitate photovoltaic fabrication processing of either substrate surface, comprising two stacked conveyors which are rotated in tandem and positioned to simultaneously engage both surfaces of a substrate to enable loading, inverting, and dispensing of the substrates traveling along the substrate production flow plane of an automated production system, and further having provisions to continually remove processing and environmental debris that may be collected on the conveyer belts as the result of coming into contact with substrate surfaces and facilitating cleaning of processing and environmental debris directly from substrate surfaces.

### BACKGROUND OF THE INVENTION

1. Field of the Invention

Embodiments of the present invention generally relate to a system used to rapidly invert and clean photovoltaic substrates during fabrication processes.

2. Description of the Related Art

Solar cells are photovoltaic (PV) devices that convert sunlight directly into electrical power. PV devices typically have one or more p-n junctions. Each junction comprises two different regions within a semiconductor material where one side is denoted as the p-type region and the other as the n-type region. When the p-n junction of the PV cell is exposed to sunlight (consisting of energy from photons), the sunlight is directly converted to electricity through the PV effect. PV solar cells generate a specific amount of electric power and cells are tiled into modules sized to deliver the desired amount of system power. PV modules are joined into panels with specific frames and connectors. The solar cells are commonly formed on a silicon substrate, which may be in the form of single or multicrystalline silicon substrates. A typical PV cell includes a p type silicon wafer, substrate or sheet typically less than about 0.3 mm thick with a thin layer of n-type silicon on top of a p-type region formed in a substrate.

The photovoltaic market has experienced annual growth rates exceeding 30% for the last ten years. Some articles have suggested that solar cell power production worldwide may exceed 10 GWp in the near future. It has been estimated that more than 95% of all photovoltaic modules are silicon wafer based. The high market growth rate in combination with the need to substantially reduce solar electricity costs has resulted in a number of challenges for inexpensively forming high quality photovoltaic devices. Therefore, one major component in making commercially viable solar cells lies in reducing the manufacturing costs required to form the solar cells by improving the device yield and increasing the substrate throughput.

To economically produce solar cells fabrication processes are typically integrated into highly automated modular systems which have been optimized to quickly handle and process large quantities of substrates. To fabricate a solar cell both sides of the substrate must be processed by these automated systems. To minimize process station complexity within the automated systems, substrates may be processed on only one side at a time, which necessitates the substrate be inverted to gain access to the opposite side for additional processing. Currently, inverting of substrates involves a mechanism that temporally removes the substrate entirely from the substrate production flow plane while it pivots the substrate. For example, a substrate conveyor, of automated substrate production system, places a substrate into a slot and then stops, whereupon the inverting mechanism pivots the slot along with the substrate vertically about an axis that is usually near the leading edge of the substrate. As the slot approaches vertical the substrate may slide down into a stop in the slot that is nearest the pivot point of the inverting mechanism. As the inverting mechanism pivots past vertical, the substrate falls over onto the support surface on the opposite side of the slot. The mechanism continues to pivot until the inverted substrate is inline with the substrate production transfer direction and resting on the conveyor of the automated substrate production system, which then transports the substrate to the next processing station. In other art, vacuum end effectors are positioned to secure substrates at three or four points similar during inverting operations.

Solar cell substrates are typically fragile and vulnerable to breakage even from minimal mechanical shocks and torsional loads. Consequently, current substrate inverting devices often minimize the potential for damage by operating at slower than desirable speed, which may directly reduce overall throughput of the automated substrate production system. Furthermore, substrate surfaces can become contaminated with processing byproducts or from other environmental sources, which compromise capture and retention of substrates during inverting steps and device yield.

A substrate inverting mechanism is needed that can provide positive, uniform, substrate retention, allowing the mechanism to operate extremely fast while at the same time reducing the potential for substrate damage. It is desirable for the substrate inverting mechanism to be minimal in size, and have an operational envelope that is centered about the substrate production flow plane of an automated substrate production system. In cases where additional processing of the current substrate surface is required and/or where substrates are being sorted and organized it is desirable for the substrate inverting mechanism to be capable of transporting substrates directly along the substrate production flow plane without inverting. Additionally, it is desirable to have an inverting mechanism that can continually clean interfaces that come into contact with the substrate and also facilitate cleaning of substrate surfaces.

### SUMMARY OF THE INVENTION

Embodiments of the present invention generally provide an apparatus for performing high-speed substrate inverting to facilitate photovoltaic fabrication processing of either substrate surface, comprising two stacked conveyors which are rotated in tandem and positioned to engage one or both major surfaces of a substrate to enable loading, inverting, and dispensing of substrates traveling along the substrate production flow plane of an automated production system.

Embodiments of the invention may further provide an apparatus for inverting substrates, comprising a first conveyor assembly having a first supporting surface and a first belt disposed over the first supporting surface, a second conveyor assembly having a second supporting surface and a second belt disposed over the second supporting surface, wherein the first supporting surface is adjacently positioned over the second supporting surface to form a gap, at least one first actuator coupled to the first belt so that the first belt can be positioned relative to the first supporting surface, and at least one second actuator coupled to the second belt so that the second belt can be positioned relative to the second supporting surface; and an inversion actuator that is coupled to the first conveyor assembly and the second conveyor assembly and is adapted to orient the first conveyor assembly and second conveyor assembly so that the first supporting surface can be disposed over the second supporting surface, or the second supporting surface can be disposed over the first supporting surface.

Embodiments of the invention may further provide a method for inverting substrates, comprising positioning a substrate having a surface in a face-down orientation on a system conveyor, transferring the substrate from the system conveyor to a first surface of a porous belt found in a first conveyor assembly, restraining the surface of the substrate against the first surface of the porous belt by applying a vacuum to a second surface of the porous belt, reorienting the surface of the substrate in a face-up orientation by rotating the first conveyor assembly, and disposing the substrate on a first surface of a porous belt found in a second conveyor assembly after reorienting the substrate.

Embodiments of the invention may further provide a method for inverting substrates, comprising positioning a substrate having a first substrate surface in a face-down orientation in a gap formed between a first conveyor assembly and a second conveyor assembly, wherein the first substrate surface is in contact with a first surface of a belt contained in the first conveyor assembly when it is positioned in the gap, reorienting the first conveyor assembly and the substrate so that the first substrate surface is in a face-up orientation, and disposing the substrate on a first surface of a belt in the second conveyor assembly after reorienting the substrate.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an isometric view of a substrate inverter system positioned along the substrate production transfer direction according to one embodiment of the invention.

FIG. 2 is an isometric view of one substrate inverter system according to one embodiment of the invention.

FIGS. 3A-3C are isometric schematic views of a substrate inverting process according to one embodiment of the invention.

FIGS. 4A and 4B illustrate a tandem conveyor motion sequence according to one embodiment of the invention.

FIGS. 5A and 5B illustrate a tandem conveyor motion sequence according to one embodiment of the invention.

FIG. 6 is an isometric view of one substrate inverter system according to another embodiment of the invention.

FIGS. 7A-7C are isometric schematic views of a substrate inverting process according to one embodiment of the invention.

FIGS. 8A and 8B illustrate a tandem conveyor motion sequence according to one embodiment of the invention.

FIGS. 9A and 9B illustrate a tandem conveyor motion sequence according to one embodiment of the invention.

FIG. 10 illustrates a schematic view of the tandem conveyors according to one embodiment of the invention.

FIG. 11 illustrates an exploded isometric schematic view of a substrate inverter system according to one embodiment of the invention.

FIGS. 12A-12C illustrate a belt actuator motion sequence according to one embodiment of the invention.

FIGS. 13A and 13B illustrate a cleaning process according to one embodiment of the invention.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention generally provide a small footprint apparatus for performing high-speed substrate inversion to facilitate photovoltaic fabrication processing on either major surface of a substrate in an automated production system. In one embodiment, the substrate inversion apparatus, or substrate inverter system, comprises two stacked conveyors which are rotated in tandem to enable loading, inverting, and dispensing of the substrates from the substrate inverter system. In one embodiment, the stacked conveyors are positioned to simultaneously engage both surfaces of a substrate during the orientation operation in the automated production system. In another embodiment, the stacked conveyors have a sufficient gap, between the upper and lower conveyor belts, so that the lower conveyor belt engages, captures, transports, inverts, and dispenses a substrate through contact with only one of the major surface of the substrate. In another embodiment, the apparatus may further have provisions to clean the conveyor belts and remove processing and environmental debris from the surface of a substrate.

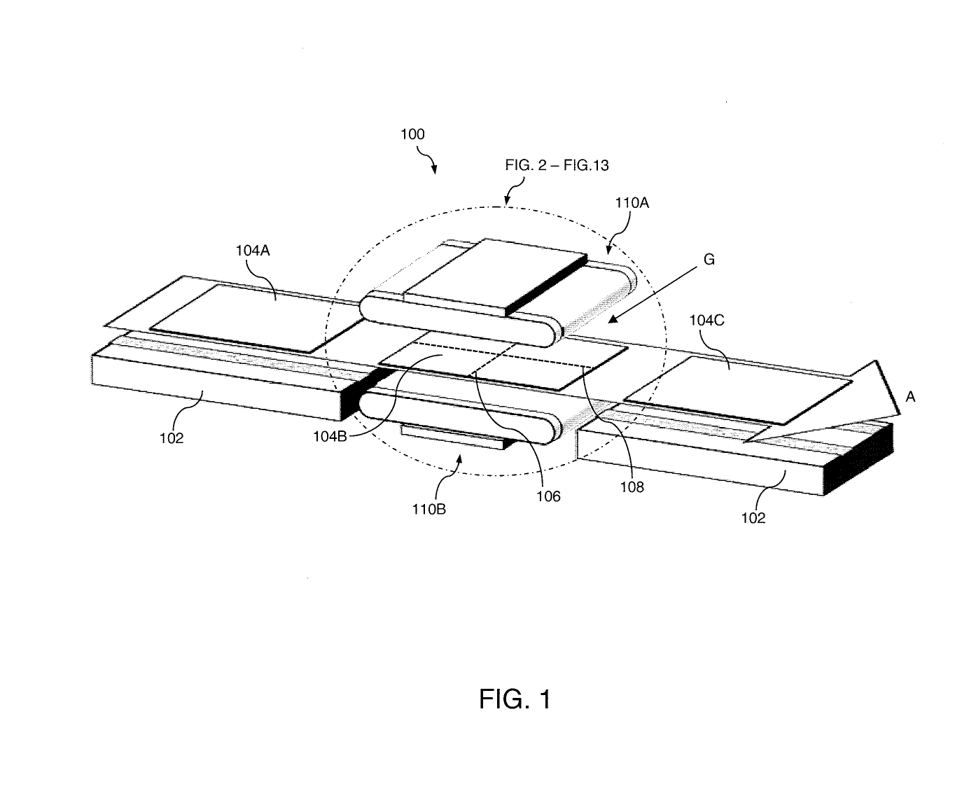

FIG. 1 is an isometric view that illustrates one embodiment of a substrate inverter system 100. In this configuration the substrate inverter system 100 is positioned to receive and transfer substrates from automatic production system conveyors 102, which are used to transfer substrates between various processing stages (not shown) in a larger substrate processing system, such as a Softline™ tool available from Baccini S.p.A. Conveyor assemblies 110A and 110B are generally positioned above and below a transfer plane that is aligned along a substrate transfer direction A to engage and support at least one surface of a substrate that is to be inverted in the substrate inverter system 100. The conveyor assemblies 110A and 110B are aligned in a stacked orientation with a gap “G” formed there between to accept, transfer, invert, and dispense substrates traveling along the substrate transfer direction A. Embodiments of the present substrate inverter system 100 can invert the substrate 104B through rotation near or about either of substrate centerlines 106, 108. Inverting through rotation about either substrate centerline 106 or 108 minimizes and balances the moments of inertia being induced on the edges of substrate 104B, thus facilitating high speed inversion. The stacked tandem conveyor assemblies 110A and 110B are generally configured to be inline with the substrate transfer direction A to enable a substrate 104A to be loaded into the substrate inverter system 100 while an already inverted substrate 104C is simultaneously exiting the substrate inverter system 100 to an automatic production system conveyor 102. To minimize the stress delivered to a substrate and conveyor belt wear the velocities of the conveyor belts on the conveyor assemblies 110A and 110B are speed matched to the automated substrate production system conveyors 102 during exchanges. Additionally, the stacked conveyor assemblies 110A and 110B facilitate the option of transferring a substrate through the substrate inverter system 100 without performing a substrate inversion step. It should be noted that inverting a substrate about one of the substrate centerlines 106 or 108 also serves to minimize the volume needed within the automated production system. The inline operation of the small footprint substrate inverter system 100 allows substrates to be quickly oriented and conveyed along the substrate transfer direction A.

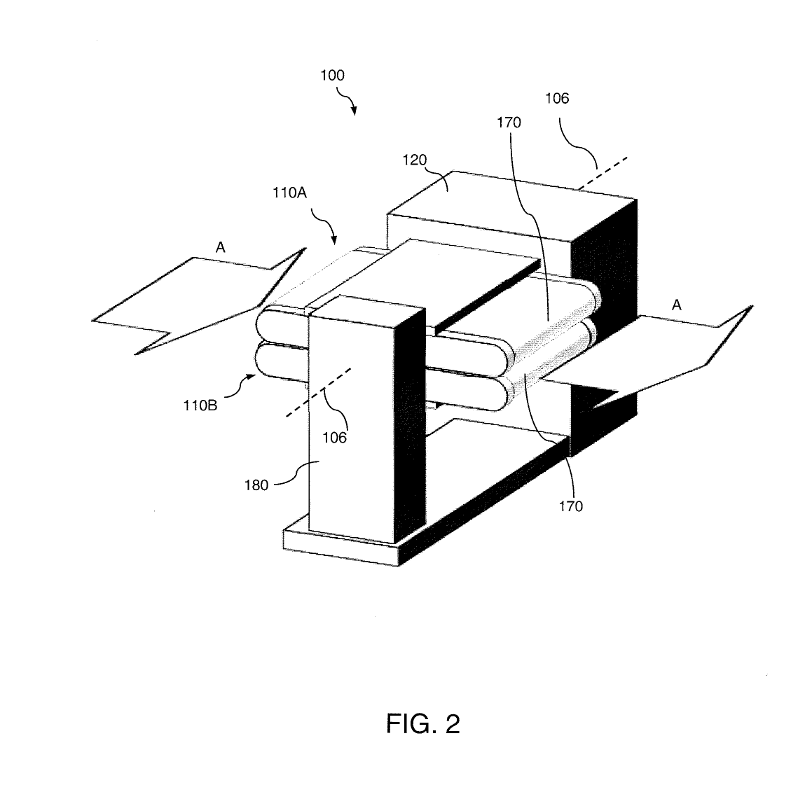

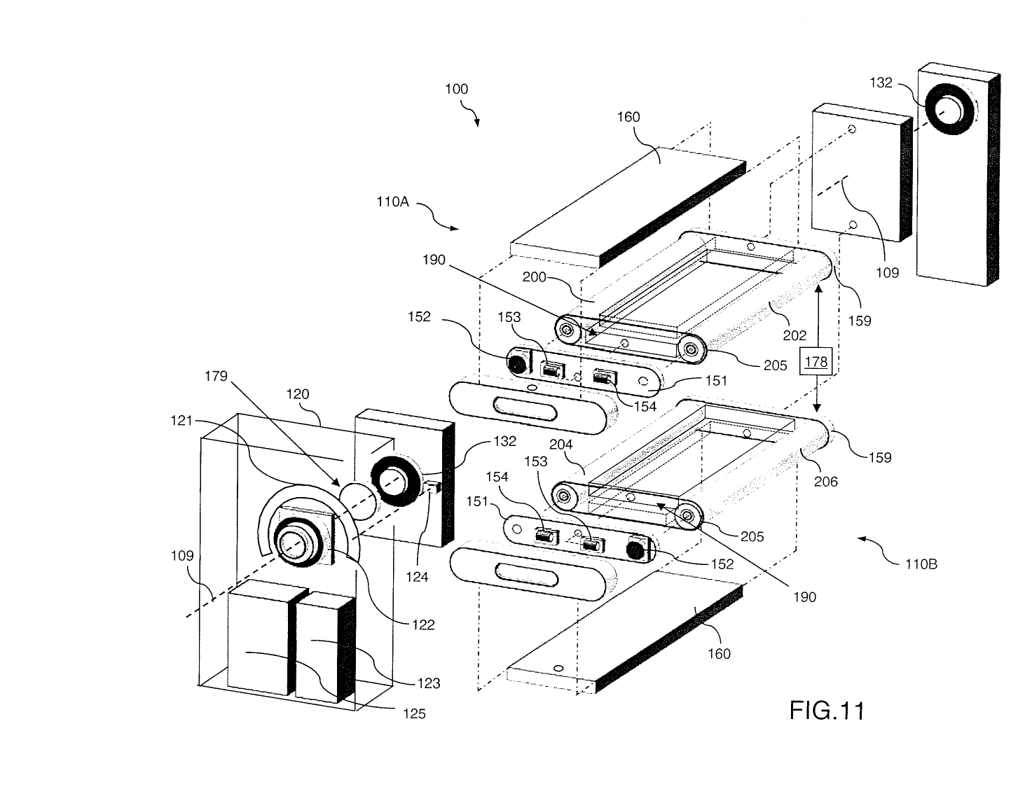

FIG. 2 illustrates one embodiment of a substrate inverter system 100 having tandem conveyor assemblies 110A and 110B positioned coplanar with the substrate transfer direction A. The substrate inverter system controller 120, using rotational actuators 152 (FIG. 11) mounted inside each conveyor assembly 110A and 110B activates the conveyor belts 170 to facilitate loading and dispensing substrates along the substrate transfer direction A. If substrate inverting is required, the conveyor belts 170 are halted when the substrate is positioned between the conveyor belts, so that a vacuum may be applied to further secure the substrate to at least one of the conveyor belts 170. The substrate inverter system 100 inverts the substrate by rotating the tandem conveyors in unison using a rotational actuator 122 (FIG. 11) which is mounted inside the substrate inverter system controller 120 and is coupled to the supporting structural elements within each of the conveyor assemblies 110A and 110B. The inverting operation can be performed about any rotation axis on, or proximate to, the substrate centerline. In this embodiment, inverting rotation takes place about substrate centerline 106 which lies 90 degrees from the substrate transfer direction A. Inverting substrates about any axis which is consistent with substrate centerline 106 results in the pre-inverted leading edge of the substrate becoming the post inverted trailing edge, with respect to the substrate transfer direction A. In automated substrate production systems, control of substrate edge orientation with respect to the substrate transfer direction A may be desirable for processing. Additionally, this method allows substrates traveling on the substrate transfer direction A to be loaded, inverted, and unloaded from either side of the tandem conveyor assemblies 110A and 110B, thus eliminating the time that would otherwise be required to reset the inverter to collect another substrate.

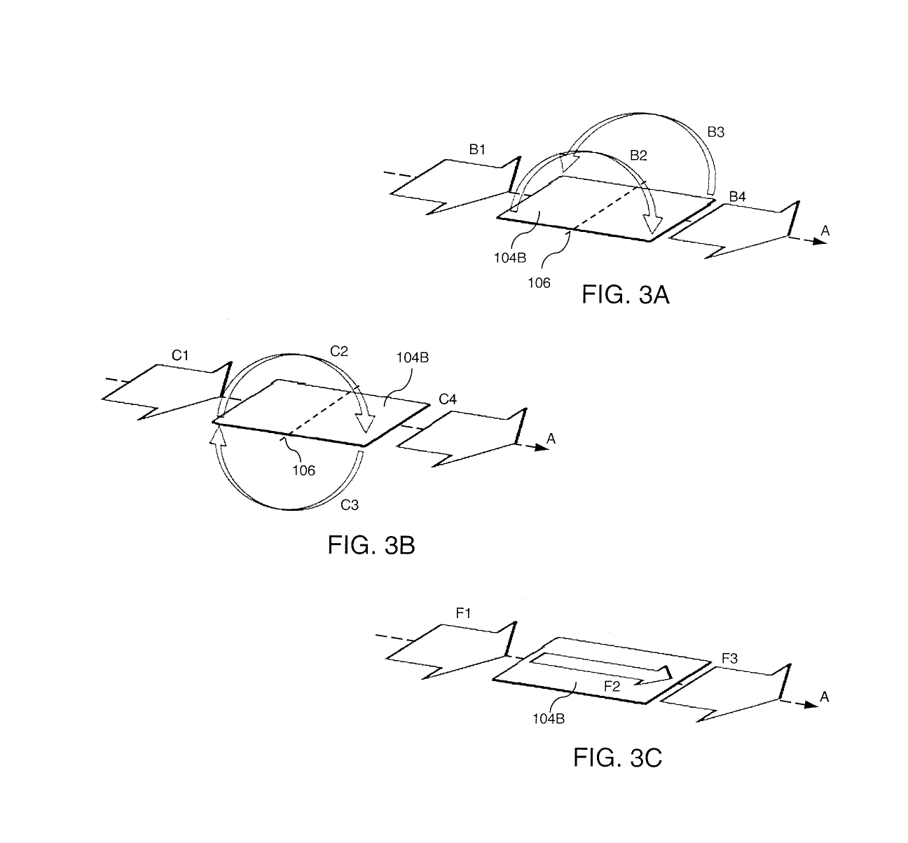

FIG. 3A illustrates an inverting method provided by the substrate inverter system illustrated in FIG. 2 where substrate 104B is loaded along path B1 that is aligned along the substrate transfer direction A into a position between the conveyor assemblies 110A and 110B within the substrate inverter system 100 (FIG. 2). The substrate inverter system controller 120 then sequentially rotates the conveyor assemblies 110A and 110B along a 180 degree clockwise path B2 about the substrate centerline 106. The inverted substrate 104B is then dispensed along path B4 while another substrate is simultaneously being loaded into the substrate inverter system. The substrate inverter system controller 120 then sequentially rotates the conveyor assemblies 110A and 110B along a 180 degree counterclockwise path B3 to invert a second substrate. The second inverted substrate is then dispensed along path B4 onto the substrate transfer direction A while another substrate is simultaneously being loaded into the substrate inverter system.

FIG. 3B illustrates an inversion method provided by the substrate inverter system illustrated in FIG. 2 where substrate 104B is loaded along path C1 that is aligned along the substrate transfer direction A into the inverting position within the substrate inverter system 100. The substrate inverter system controller 120 then rotates the conveyor assemblies 110A and 110B in 180 degree clockwise increments along paths C2 and C3 about the substrate centerline 106 to sequentially invert each substrate placed between the conveyor assemblies 110A and 110B. Alternately, the substrate inverter system controller 120 could also rotate the conveyor assemblies 110A and 110B in 180 degree counterclockwise increments about the substrate centerline 106. In one embodiment, each of the sequentially inverted substrates 104B are then dispensed along path C4 while another substrate is simultaneously being loaded into the substrate inverter system.

FIG. 3C illustrates a direct substrate transfer method provided by the substrate inverter system illustrated in FIG. 2 where substrate 104B is loaded along path F1 that is aligned along the substrate transfer direction A, transferred through the substrate inverter along path F2 where it is then dispensed along path F3, while another substrate is simultaneously being loaded into the substrate inverter system.

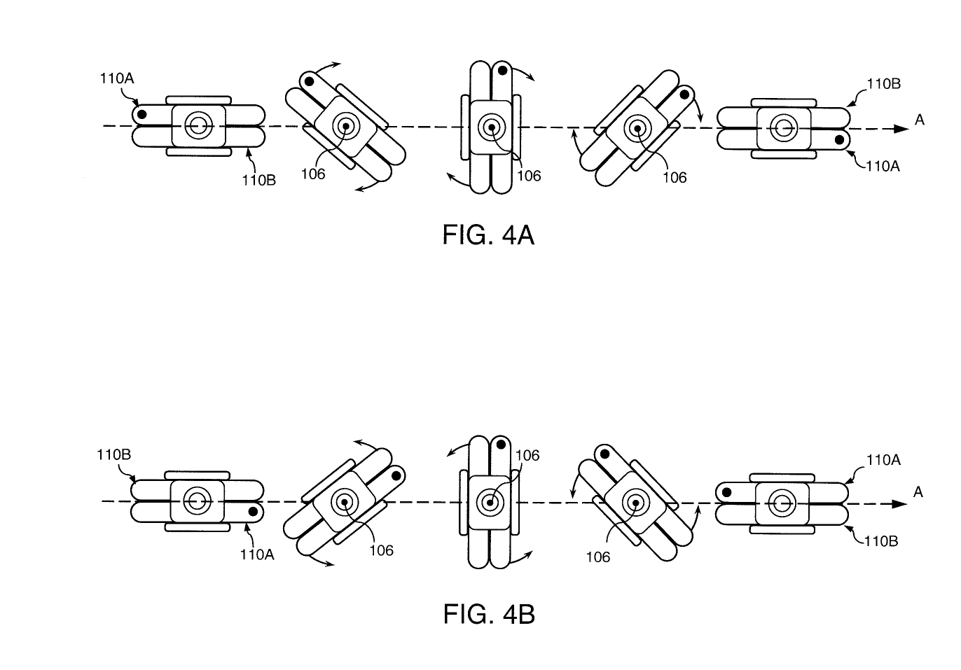

FIG. 4A illustrates the rotation of conveyor assemblies 110A and 110B to provide the rotation along path B2 illustrated in FIG. 3A by use of a rotational actuator 122 (FIG. 11) that is coupled to conveyor assemblies 110A and 110B. For clarity the left side of conveyor assembly 110A has been marked with a dark “dot.” In one example, initially conveyor assembly 110A is positioned above conveyor assembly 110B and the conveyor assemblies 110A and 110B are positioned and aligned to accept a substrate traveling along the substrate transfer direction A. In this case rotation is performed in a 180 degree clockwise direction about the substrate centerline 106 and reoriented to the substrate transfer direction A whereupon the inverted substrate is transferred along the substrate transfer direction A. This rotation results in conveyor assembly 110B being positioned above conveyor assembly 110A. This method allows the next substrate to be loaded into the substrate inverter system while simultaneously dispensing the inverted substrate onto the substrate transfer direction A. Additionally, this method allows substrates traveling on the substrate transfer direction A to be loaded, inverted, and dispensed from either side of the tandem conveyor assemblies 110A and 110B, thus eliminating the time that would be otherwise be required to reset the inverter to collect another substrate.

FIG. 4B illustrates the rotation of tandem conveyor assemblies 110A and 110B to provide rotation along path B3 illustrated in FIG. 3A using a rotational actuator 122 (FIG. 11) contained within the substrate inverter system 100. In one example, initially conveyor assembly 110B is positioned above conveyor assembly 110A and the conveyors 110B and 110A are positioned and aligned to accept a substrate that is transferred along the substrate transfer direction A. In this case rotation is performed in a 180 degree counterclockwise direction about the substrate centerline 106, whereupon the inverted substrate is dispensed in the substrate transfer direction A. This rotation results in conveyor assembly 110A being repositioned above conveyor assembly 110B, consistent with FIG. 4A, so that the process sequence can be repeated. This method allows the next substrate to be loaded into the substrate inverter system 100 while simultaneously dispensing the inverted substrate along the substrate transfer direction A. Additionally, this method allows substrates traveling on the substrate transfer direction A to be loaded, inverted, and dispensed from either of the conveyor assemblies 110A and 110B, thus eliminating the time that would otherwise be required to reset the inverter to collect another substrate.

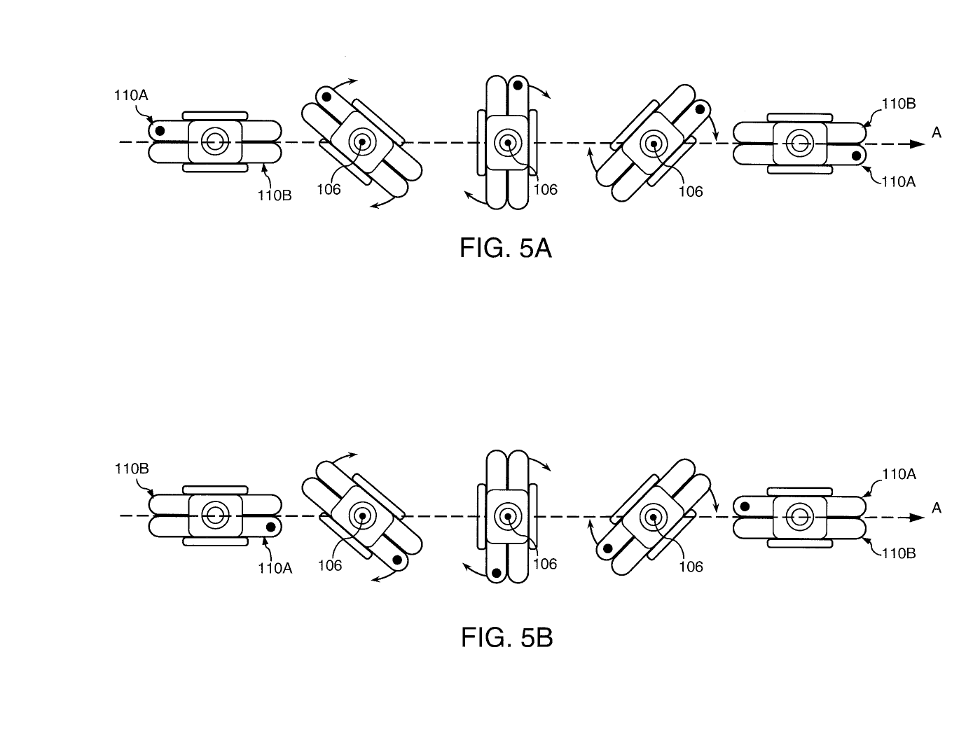

FIG. 5A illustrates the rotation of conveyor assemblies 110A and 110B to provide rotation along path C2 in FIG. 3B using a rotational actuator 122 (FIG. 11) contained in the substrate inverter system 100. For clarity the left side of conveyor assembly 110A has been marked with a “dot.” In one example, initially the conveyor assembly 110A is positioned over conveyor assembly 110B and the tandem conveyor assemblies 110A and 110B are positioned and aligned to accept a substrate traveling along the substrate transfer direction A. In this case rotation is performed in a 180 degree clockwise direction about the substrate centerline 106 to reorient the substrate. This rotation results in conveyor assembly 110B being positioned over conveyor assembly 110A. This method allows the next substrate to be loaded into the substrate inverter system 100 while simultaneously dispensing the inverted substrate along the substrate transfer direction A. Additionally, this method allows substrates to be loaded, inverted, and dispensed from either of the tandem conveyor assemblies 110A and 110B, thus avoiding the time that would otherwise be required to reset the inverter to collect another substrate.

FIG. 5B illustrates the rotation of conveyor assemblies 110A and 110B to provide rotation along path C3 as shown in FIG. 3B using a rotational actuator 122 (FIG. 11) contained within the substrate inverter system 100. In one example, initially conveyor assembly 110B is positioned over conveyor assembly 110A and the conveyors 110B and 110A are positioned and aligned to accept a substrate travelling along the substrate transfer direction A. In this case rotation is performed in a 180 degree clockwise direction about the substrate centerline 106, whereupon the inverted substrate is dispensed in a substrate transfer direction A. This rotation results in conveyor assembly 110A being repositioned over conveyor assembly 110B, consistent with FIG. 5A where the process sequence is repeated. This method allows the next substrate to be loaded into the substrate inverter system 100 while simultaneously dispensing an inverted substrate along the substrate transfer direction A. Additionally, this method allows substrates traveling along the substrate transfer direction A to be loaded, inverted, and dispensed from either of the tandem conveyor assemblies 110A and 110B, thus eliminating the time that would otherwise be required to reset the inverter to collect another substrate.

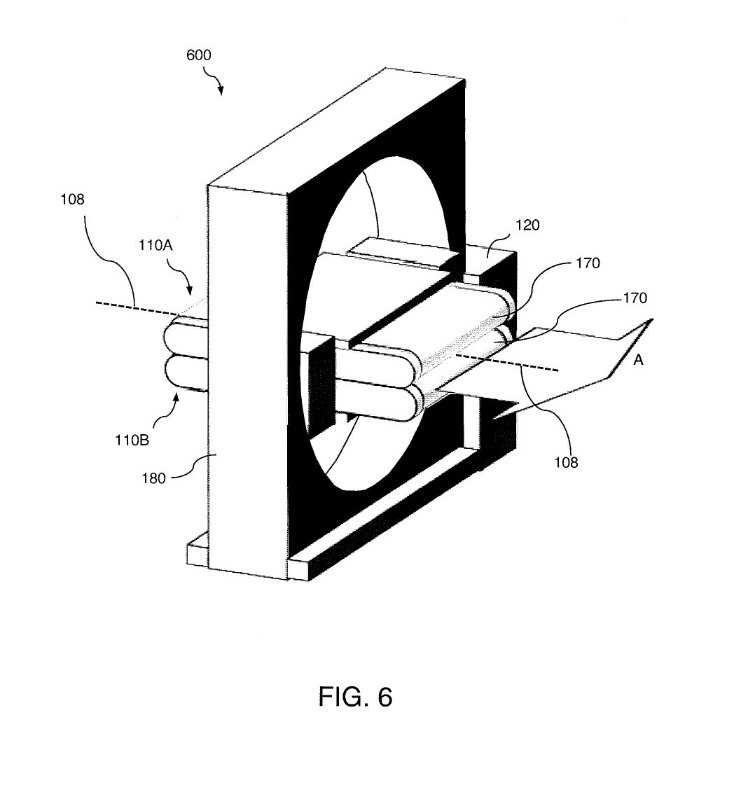

FIG. 6 illustrates another embodiment of a substrate inverter system 600 with conveyor assemblies 110A and 110B being positioned coplanar with a horizontal plane that is aligned along the substrate transfer direction A. The substrate inverter system controller 120 is generally coupled to one or more rotational actuators 152 (FIG. 11) mounted inside each of the conveyor assemblies 110A and 110B, which are each used to control the movement of the conveyor belts 170 to facilitate loading and dispensing of the substrates along the substrate transfer direction A. If substrate inversion is required, the conveyor belts 170 are halted when the substrate is positioned between the conveyor assemblies 110A and 110B where vacuum may be applied to a major surface of the substrate through at least one of the conveyor belts 170 to secure the substrate during the inversion process. The substrate inverter system 600 then inverts the substrate by rotating the conveyor assemblies 110A and 110B in unison using a rotational actuator 122 (FIG. 11) which is mounted inside the substrate inverter system controller 120 and coupled to the structural components (e.g., reference numerals 151 and 159 in FIG. 11) contained in each of the conveyor assembly 110A and 110B. In one embodiment, a ring gear (not shown) that is disposed within the housing 180 and coupled to the structural components contained in each of the conveyor assemblies 110A and 110B, is driven by the rotational actuator found in the substrate inverter system controller 120 to cause the conveyor assembly 110A and 110B and substrate to be inverted. The inversion operation can be performed about any rotation axis on, or proximate to, a substrate centerline. In one embodiment, the rotation takes place about a rotation axis that is parallel to the substrate centerline 108 which is also aligned along the substrate transfer direction A. Inverting substrates about any axis which is consistent with substrate centerline 108 results in the pre-inverted leading edge of the substrate remaining the leading edge after inversion. In automated substrate production systems, control of substrate edge orientation with respect to the substrate transfer direction A may be desirable for alignment and processing. Additionally, this method allows substrates traveling along the substrate transfer direction A to be loaded, inverted, and dispensed from either end of the tandem conveyor assemblies 110A and 110B, thus eliminating the time that would otherwise be required to reset the inverter to collect another substrate. It should be noted that the conveyor assemblies 110A and 110B and other supporting components discussed in conjunction with FIGS. 1, 2, 10 and 11 are similar to the components illustrated in FIG. 6, and thus like reference numerals have been used where appropriate.

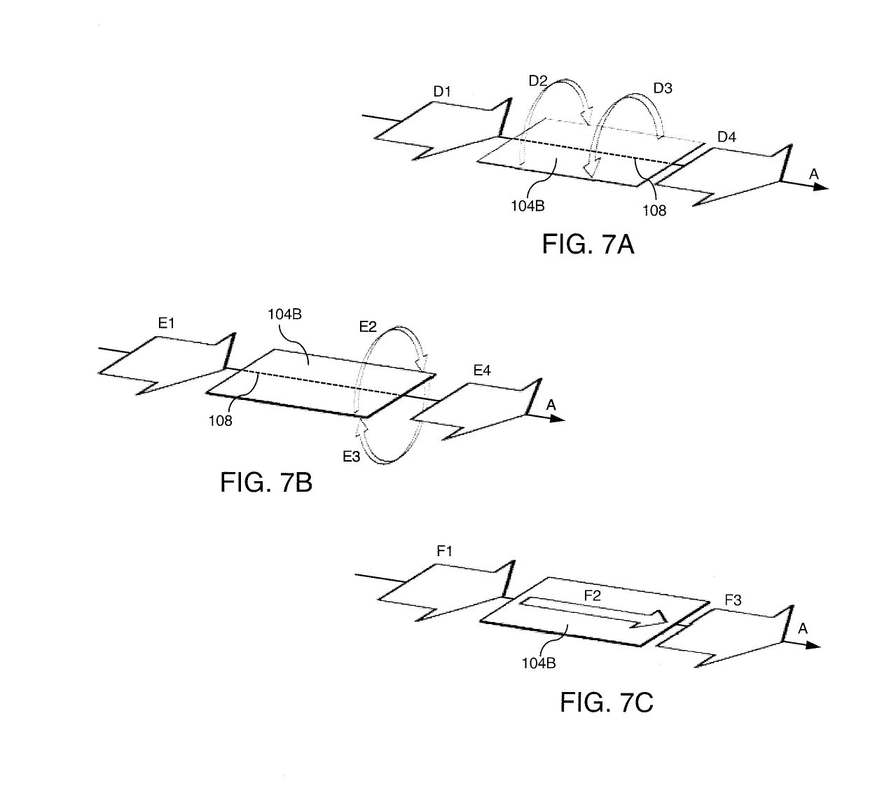

FIG. 7A illustrates an inverting method provided by the substrate inverter system 600 illustrated in FIG. 6 where substrate 104B is loaded along path D1 into the inverting position within the substrate inverter system 600. The substrate inverter system controller 120 can generally rotate the conveyor assemblies 110A and 110B alternately in a clockwise path D2 and counterclockwise path D3 about the substrate centerline 108. In one embodiment, during processing the substrate inverter system controller 120 then sequentially rotates the conveyor assemblies 110A and 110B along a 180 degree clockwise path D2 about the substrate centerline 108. The inverted substrate 104B is then dispensed along path D4 onto the substrate transfer direction A while another substrate is simultaneously being loaded into the substrate inverter system. The substrate inverter system controller 120 then sequentially rotates the conveyor assemblies 110A and 110B along a 180 degree counterclockwise path D3 to invert a second substrate. The second inverted substrate is then dispensed along path D4 onto the substrate transfer direction A while another substrate is simultaneously being loaded into the substrate inverter system.

FIG. 7B illustrates an inverting method provided by the substrate inverter system 600 illustrated in FIG. 6 where substrate 104B is loaded along path E1 into the inverting position within the substrate inverter system 600. The substrate inverter system controller 120 rotates the conveyor assemblies 110A and 110B alternately in 180 degree clockwise increments along paths E2 and E3 about the substrate centerline 108 to sequentially invert each substrate placed between the conveyor assemblies 110A and 110B. Alternately, the substrate inverter system controller 120 could also rotate the conveyor assemblies 110A and 110B in 180 degree counterclockwise increments about the substrate centerline 108. The inverted substrate is then dispensed along path E4 onto the substrate transfer direction A, while another substrate is simultaneously being loaded into the substrate inverter system 600.

FIG. 7C illustrates a direct substrate transfer method provided by the substrate inverter system 600 illustrated in FIG. 6 where substrate 104B is loaded along path F1, transferred through the substrate inverter system 600 along path F2, where it is then dispensed along path F3, while another substrate is simultaneously being loaded into the substrate inverter system.

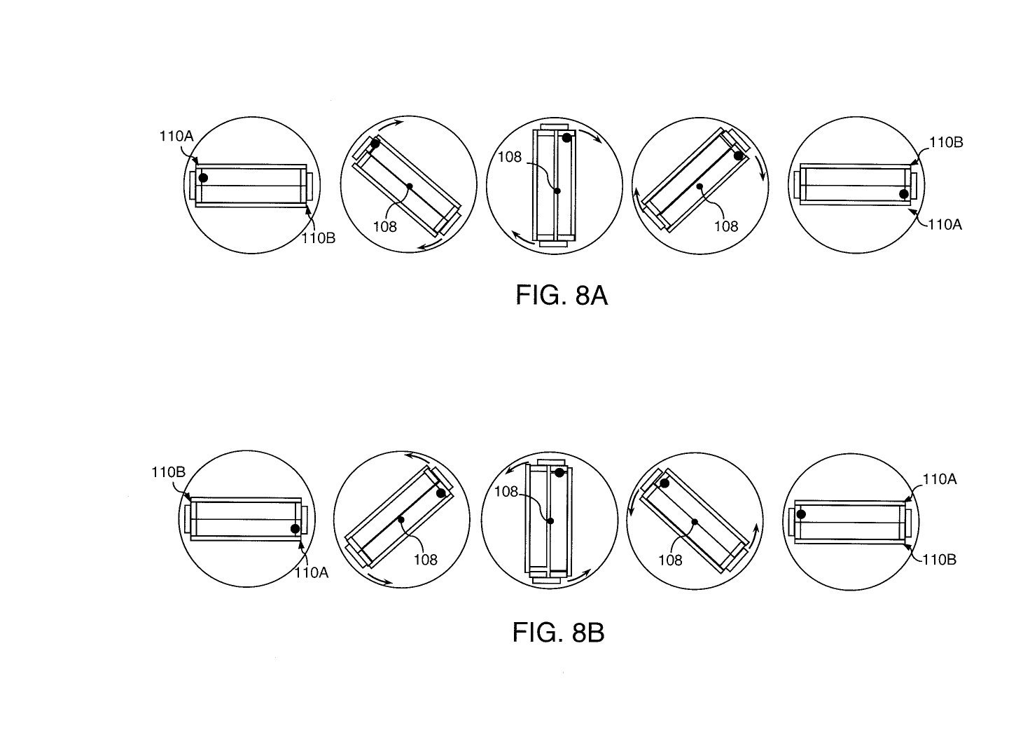

FIG. 8A illustrates the rotation of the conveyor assemblies 110A and 110B, viewed from a position along the substrate transfer direction A using the substrate inverter system 600 illustrated in FIG. 6. For clarity the left corner of conveyor assembly 110A has been marked with a “dot.” In one example, initially conveyor assembly 110A is positioned over conveyor assembly 110B, and the conveyor assemblies 110A and 110B are positioned and aligned to accept a substrate traveling along the substrate transfer direction A. In this case rotation is performed in a clockwise direction about the substrate centerline 108 to reorient the substrate. In this case the substrate centerline 108 coincides with the substrate transfer direction A. This rotation results in conveyor assembly 110B being positioned over conveyor assembly 110A. This method allows the next substrate to be loaded into the substrate inverter system 600 while simultaneously dispensing the inverted substrate along the substrate transfer direction A. Additionally, this method allows substrates traveling along the substrate transfer direction A to be loaded, inverted, and dispensed from either orientation of the tandem conveyor assemblies 110A and 110B, thus eliminating the time that would be otherwise be required to reset the inverter to collect another substrate.

FIG. 8B illustrates the rotation of the conveyor assemblies 110A and 110B, viewed from a position along the substrate transfer direction A using the substrate inverter system 600 illustrated in FIG. 6. In one example, initially conveyor assembly 110B is positioned over conveyor assembly 110A, and the conveyor assemblies 110B and 110A are positioned and aligned to accept a substrate along the substrate transfer direction A. In this case rotation is performed in a counterclockwise direction about the substrate centerline 108, whereupon the inverted substrate is delivered along the substrate transfer direction A. In this case the substrate centerline 108 coincides with the substrate transfer direction A. This rotation results in conveyor assembly 110A being repositioned over conveyor assembly 110B, consistent with FIG. 8A where the process sequence is repeated. This method allows the next substrate to be loaded into the substrate inverter system 600 while simultaneously dispensing an inverted substrate along the substrate transfer direction A. Additionally, this method allows substrates traveling on the substrate transfer direction A to be loaded, inverted, and dispensed from either orientation of the tandem conveyor assemblies 110A and 110B, thus eliminating the time that would otherwise be required to reset the inverter to collect another substrate.

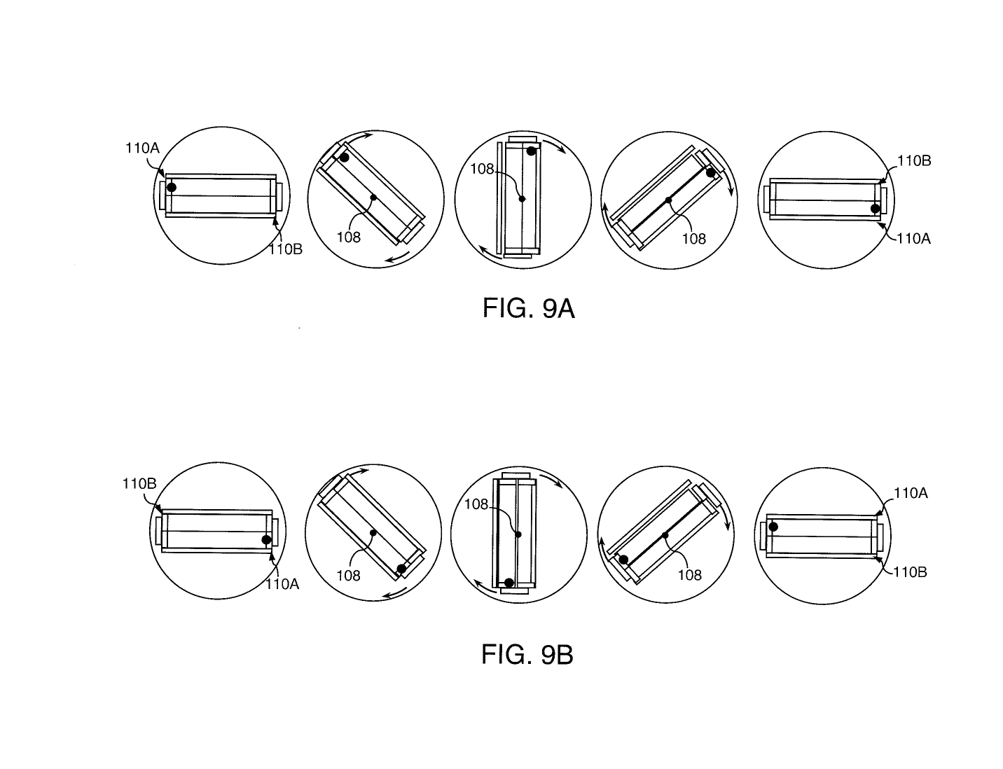

FIG. 9A illustrates the rotation of tandem conveyor assemblies 110A and 110B, viewed from a position along the substrate transfer direction A using the substrate inverter system 600 illustrated in FIG. 6. For clarity the left side of conveyor assembly 110A has been marked with a “dot.” Initially conveyor assembly 110A is positioned over conveyor assembly 110B, and conveyor assemblies 110A and 110B are positioned and aligned to accept a substrate traveling along the substrate transfer direction A. In this case rotation is performed in a clockwise direction about the substrate centerline 108 whereupon the inverted substrate is then delivered along the substrate transfer direction A. This rotation results in conveyor assembly 110B being positioned above conveyor assembly 110A. This method allows the next substrate to be loaded into the substrate inverter system 600 while simultaneously delivering the inverted substrate along the substrate transfer direction A. Additionally, this method allows substrates traveling along the substrate transfer direction A to be loaded, inverted, and dispensed from either orientation of the tandem conveyor assemblies 110A and 110B, thus avoiding the time that would otherwise be required to reset the inverter to collect another substrate.

FIG. 9B illustrates the rotation of tandem conveyor assemblies 110A and 110B, viewed from a position along the substrate transfer direction A using the substrate inverter system 600 illustrated in FIG. 6. In one example, initially conveyor assembly 110B is positioned over conveyor assembly 110A, and conveyor assemblies 110A and 110B are positioned and aligned to accept a substrate along the substrate transfer direction A. In this case rotation is performed in a clockwise direction about the substrate centerline 108 whereupon the inverted substrate is delivered along the substrate transfer direction A. This rotation results in conveyor assembly 110A being repositioned over conveyor assembly 110B, consistent with FIG. 9A where the process sequence is repeated. This method allows the next substrate to be loaded into the substrate inverter system 600 while simultaneously dispensing the inverted substrate onto the substrate transfer direction A. Additionally, this method allows substrates traveling along the substrate transfer direction A to be loaded, inverted, and unloaded from either end of the tandem conveyor assemblies 110A and 110B, thus eliminating the time that would otherwise be required to reset the inverter to collect another substrate.

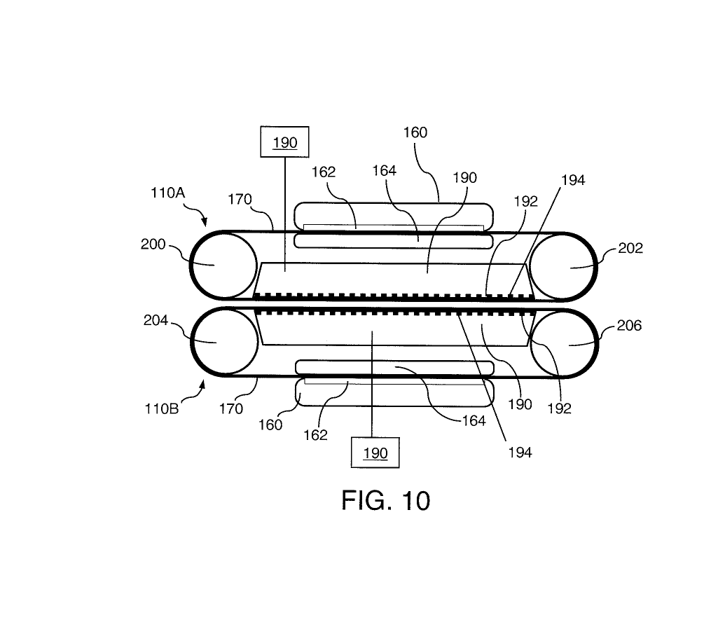

FIG. 10 illustrates a schematic cross-sectional view of one embodiment of the conveyor assemblies 110A and 110B. In one embodiment, a conveyor belt 170 is coupled to drive shafts 200 and 202 contained in conveyor assembly 110A, and a second conveyor belt 170 is coupled to drive shafts 204 and 206 contained in conveyor assembly 110B. In one embodiment, a rotational actuator 152 (FIG. 11), which is controlled by the substrate inverter system controller 120, is coupled to one of the drive shafts 200 and 202 in the conveyor assembly 110A, and a second rotational actuator 152 (FIG. 11), which is also controlled by the substrate inverter system controller 120, is coupled to the drive shafts 204 and 206 in the conveyor assembly 110B. In one embodiment, the conveyor belts 170 in each of the conveyor assemblies 110A and 110B are operated independently, through use of commands sent by the substrate inverter system controller 120 to each of the rotational actuators 152. In one embodiment, the elastic properties of the conveyor belts 170, in combination with the spacing between the two conveyor assemblies 110A and 110B is used to adjust for variations in substrate thickness, substrate warpage and planarity of the conveyors.

Additionally, each of the conveyor belts 170 may be porous to allow a fluid to be transferred from one side of a conveyor belt 170 to the other. In one embodiment, the conveyor belts 170 are formed from a soft, compliant and porous material, such as a polyurethane foam, or other similar material. In one embodiment, isolation valves 153, 154, which are controlled by the substrate inverter system controller 120, can be used to selectively control the flow of gas between the gas source 194 and the plenum 190. In one example, a sub-atmospheric pressure (e.g., vacuum) can be created at one surface of a conveyor belt 170 due to the application of a vacuum applied to an opposing surface that is in fluid communication with a fluid source 194. In one aspect, a substrate is captured and retained on a porous conveyor belt 170 disposed over the supporting surface 192 by providing a vacuum pressure within the ports 193. In one configuration, the fluid source 194 is a vacuum pump, or vacuum ejector, that is adapted to provide a vacuum to a surface of the conveyor belt 170 from one or more ports 193 formed in the plenum 190.

Alternatively, a gas can be delivered to a surface of a conveyor belt 170 and/or substrate due to the application of a positive gas pressure applied to an opposing surface of the conveyor belt 170 that is in fluid communication with a fluid source 194. In one embodiment, each of the conveyor assemblies 110A and 110B has a plenum 190 that is used to spread and direct a flow of fluid through one or more ports 193 formed in a supporting surface 192 onto the inside surface of the conveyor belts, through the conveyor belt and to the opposing surface of the conveyor belt. In one embodiment, the gas source 194 is adapted to deliver an inert gas, such as nitrogen to a conveyor belt 170 from one or more ports 193 formed in the plenum 190.

In one embodiment, the conveyor assemblies 110A and 110B each has at least one conveyor belt cleaning station components 160, 162, and 164 that are positioned within each conveyor assembly 110A and 110B to optionally clean the conveyor belts 170 during transferring or maintenance activities. In one embodiment, the conveyor belt cleaning station components 160, 162, and 164 can each be configured to remove any accumulated debris transferred from substrate surfaces to the conveyor belt 170. In one configuration, the cleaning station components 160, 162, and 164 use a wiping process, electrostatic particle attraction process, air knife, or chemical cleaning process to clean a surface of the conveyor belt 170. In some cases, the collected material debris is transported away from the cleaning station components 160, 162, and 164 manually or through the use of a negative pressure exhaust line (not shown).

FIG. 11 illustrates an exploded isometric view of one embodiment of the functional elements typically found in the substrate inverter system 100 illustrated in FIGS. 1 and 2. In one embodiment, the substrate inverter system controller 120 incorporates a gas source 194, a motion sequencing module 123, a hollow shaft rotational actuator 122, and an electrical interface coupling slot 121. In one embodiment, the gas source 194 comprises a vacuum control module 125 that facilitates the control and delivery of vacuum, exhaust and/or clean dry air to one the plenums 190 found in the conveyor assemblies 110A and 110B. In one configuration, the delivery of vacuum, exhaust, and clean dry air is delivered to one the plenums 190 using a conventional rotating fluid coupling 179 and tubing (not shown) that are positioned between the plenums 190 and fluid source 194. In one configuration, the vacuum, exhaust and clean dry air is selectively controlled by use of one or more isolation valves 153 and 154 that are positioned between the gas source 194 and the plenums 190. In one configuration, an isolation valve 153, 154 (e.g., electromechnical valve) is mounted on the structural support plate 151 found in each of the conveyor assemblies 110A and 110B, and is used to selectivity provide vacuum to the plenum 190 and/or the conveyor cleaning stations 160. In one embodiment, the plenum 190, drive shafts (e.g., reference numerals 200 and 202), rotational actuator 152, and conveyor cleaning station 160 components are all supported and mounted to the structural support plates 151 and 159 so that the components in each of the conveyor assemblies 110A and 110B can be maintained in a desired fixed configuration.

The substrate inverter system controller 120 is also generally used to facilitate the control and automation of the substrate inverter system 100, 600, and also other components that are coupled to the substrate inverter system 100, 600. The substrate inverter system controller 120 may also include a central processing unit (CPU) (not shown), memory (not shown), and support circuits (or I/O) (not shown). The CPU may be one of any form of computer processors that are used in industrial settings for controlling various chamber processes and hardware (e.g., conveyors, detectors, motors, fluid delivery hardware, etc.) and monitor the system and chamber processes (e.g., substrate position, process time, detector signal, etc.). The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the substrate inverter system controller 120 determines which tasks are performable on a substrate. Preferably, the program is software readable by the substrate inverter system controller 120, which includes code to generate and store at least substrate positional information, the sequence of movement of the various controlled hardware components, and any combination thereof.

The motion sequencing module 123 electrically communicates with the substrate inverter system controller 120, and is used to control the operational modes and behaviors of the substrate inverter system 100, 600, based on the software instructions and data coded and stored within the memory and task status and diagnostic information received. The motion sequencing module 123 interfaces with the hollow shaft rotational actuator 122 which is used to rotationally position the conveyor assemblies 110A and 110B about centerline axis 109. In one embodiment, the centerline axis 109 is aligned with the substrate centerline 106 (FIG. 1). The hollow shaft rotational actuator 122 may be a servomotor, a stepper motor, or a pneumatic rotation actuator device that has rotational position encoders and/or limit switch 124 positional feedback to define the actual rotational position of the conveyor assemblies 110A and 110B. In one embodiment, the motion sequencing module 123 also interfaces with the rotational actuators 152 which are coupled to one of the drive shafts 200, 202, 204 and/or 206 and positioned on the support plates 151 found in the conveyor assemblies 110A and 110B. The rotational actuators 152 may be a servomotor or a stepper motor that are each adapted to drive and control the rotational position of a conveyor belt 170 by commands sent from the substrate inverter system controller 120. In one configuration, the rotational actuators 152 are coupled directly to a primary conveyor drive shaft in each of the conveyor assemblies 110A and 110B, such the conveyor drive shaft 200 in conveyor assembly 110A and conveyor drive shaft 206 in conveyor assembly 110B. Drive belts 205 may be used to positively couple the rotation of the primary conveyor belt drive shafts 200, 206 to the secondary conveyor belt drive shafts 202, 204 in each conveyor assembly 110A and 110B. In one configuration, the rotational actuators 152 are each rotationally coupled to its respective conveyor belt 170 through the friction created between the conveyor belt 170 and the primary conveyor drive shafts 200, 204, due to a pre-applied tension created between the conveyor belt 170 and the drive shafts 200 and 202, or drive shafts 204 and 206.

In one embodiment, electrical connections made between the motion sequencing module 123 and the various electrical components in the conveyor assemblies 110A and 110B can be provided through a flexible cable harness (not shown). The electrical interconnection can be maintained through the use of the flexible cable harness disposed through a electrical interface coupling slot 121 located on the substrate inverter system controller 120, or through the use a rotating electrical interface 132, such as a slip ring type connection or mercury type rotation feed-through.

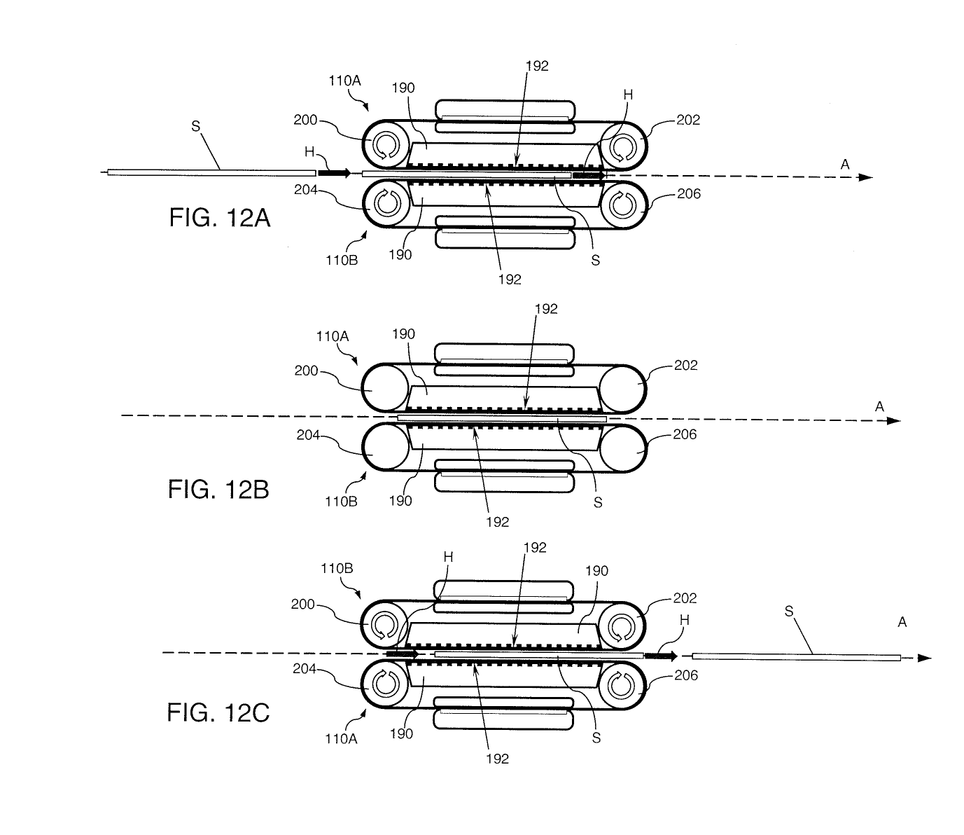

FIGS. 12A through 12C illustrate one embodiment of an operation sequence in which the conveyor assemblies 110A and 110B are used to load, invert, and deliver a substrate along the substrate transfer direction A. FIG. 12A illustrates one example of a loading operation which starts with the conveyor assembly 110A positioned over conveyor assembly 110B. During the loading operation the conveyor belt drive shafts 200, 202, 204, and 206 are operated at substantially the same speed, and in a direction “H” that is consistent with the automatic production system conveyors 102 (FIG. 1). This speed matching serves to minimize the stress delivered to the substrates, and minimize the particles generated from the abrasion of the conveyor belt surfaces and the substrate “S” surface during the loading operation.

As illustrated in FIG. 12B, during the inversion process the conveyor drive shafts 200, 202, 204, and 206 are halted with the substrate “S” positioned between the conveyor assemblies 110A and 110B. Vacuum may be applied to further secure the substrate “S” to a conveyor belt 170 and its respective supporting surface 192 in at least one of the conveyor assemblies 110A and 110B. Securing the substrate to at least one of the supporting surfaces 192 can further facilitate high speed inversion of the substrate. The substrate “S” is then inverted by use of the hollow shaft rotational actuator 122 (FIG. 11) that is used to rotate the conveyor assemblies 110A and 110B and the secured substrate. In one configuration, after the substrate has been re-oriented the vacuum applied to the substrate “S” is then released to allow the substrate “S” and conveyor belt 170 to be freely moved during the subsequent dispensing operation step. In one example, the substrate “S” is released from the supporting surface 192 contained within the conveyor assembly 110B so that the other major surface of the substrate “S” can now primarily contact, or drop-on, the surface of the conveyor belt 170 found in the conveyor assembly 110A.

FIG. 12C illustrates the post inverted substrate “S” dispensing operation in which the conveyor belt drive shafts 200, 202, 204, and 206 are operated at substantially the same speed so that the substrate “S” can be moved in a direction “H” at a consistent speed with the automatic production system conveyors 102 (FIG. 1). Matching the speed of the conveyor belts 170 and the automatic production system conveyors 102 serves to minimize the stress provided to the substrate(s) and the deterioration (caused by rubbing abrasion) of conveyor belt 170 surfaces during the substrate exchange processes. During the dispensing operation another substrate may be simultaneously loaded from the substrate transfer direction A.

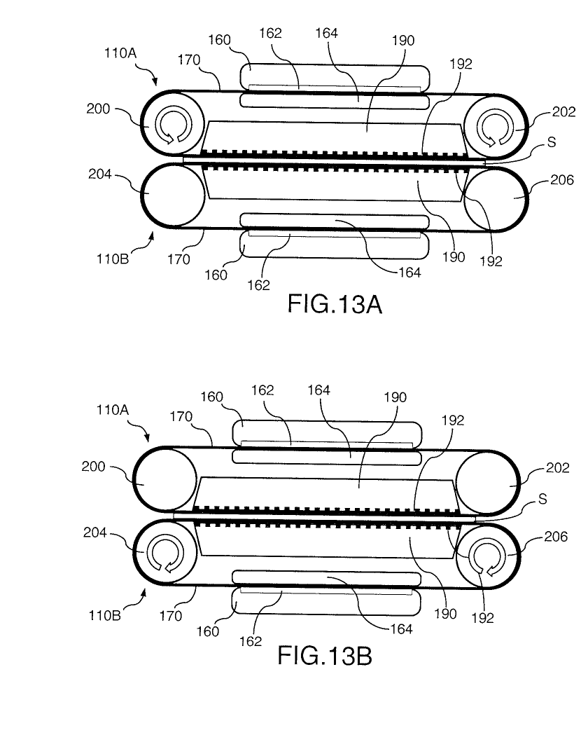

FIGS. 13A and 13B illustrate one embodiment of substrate inverter system where at least one surface of the substrate “S” is cleaned. In one case, the conveyor belt 170 in the conveyor assembly 110B is held stationary and a vacuum is applied to the plenum 190 to secure the substrate “S” to the supporting surface 192 in conveyor assembly 110B, while the conveyor belt 170 in the conveyor assembly 110A is moved in one direction, or alternating directions, across a surface of the substrate “S”. In another case, conveyor belt 170 in the conveyor assembly 110B is held stationary and a vacuum is applied to the plenum 190 to secure the substrate “S” to the supporting surface 192 in conveyor assembly 110A, while the conveyor belt 170 of conveyor assembly 110B is moved in one direction, or alternating directions, across a surface of the substrate “S”.

In one embodiment, conveyor belt 170 cleaning can be performed through a combination of brush like wiping, electrostatic, or chemical means provided from the cleaning source assembly 162 and/or through a positive pressure differential applied across the conveyor belt 170 from a pressure supplied by the fluid source 164 which can direct clean dry air through the backside of the conveyor belt 170 to dislodge particles. Any collected materials can be transported away from the cleaning station manually or through a negative pressure exhaust line (not shown). In one embodiment, the cleaning source assembly 162 is coupled to a fluid source that is adapted to direct a fluid, such as a gas to a surface of the conveyor belt 170 found in one of the conveyor assemblies 110A and 110B.

Referring to FIG. 1, in one embodiment the conveyor assemblies 110A and 110B are aligned in a stacked orientation with a gap “G” formed there between to accept, transfer, invert, and dispense substrates traveling along the substrate transfer direction A. In one embodiment, the gap “G” formed between the conveyor assemblies 110A and 110B is preset so that the a substrate will only come into contact with the conveyor assembly 110A, 110B, and its conveyor belt 170, that is positioned in a face-up orientation. For example, the substrate 104B will contact the conveyor belt 170 in the conveyor assembly 110B (e.g., face-up orientation) when the substrate inverter system 100 is oriented as shown in FIG. 1. As shown in FIG. 1, the conveyor assembly 110A is in a face-down configuration. In one example, the gap “G” is set just large enough so that a substrate that has a standard thickness and warpage will not contact the conveyor belt 170 in the opposing conveyor assembly (e.g., conveyor assembly 110A in FIG. 1) when it is positioned on a supporting conveyor assemblies (e.g., conveyor assembly 110B in FIG. 1). This configuration may be useful to prevent particle generation due to abrasion of the unsupported surface of the substrate as it is loaded between the conveyor assemblies 110A and 110B, and also minimize the particle generation due to the distance the substrate will have to shift as it is transferred from one conveyor assembly to the other due to gravity during the inversion process.

In another embodiment, the gap “G” formed between the conveyor assemblies 110A and 110B is preset so that the substrate 104B will contact both of the conveyor belts 170 in the conveyor assemblies 110A and 110B during the inversion process. For example, the gap “G” is set to a nominal distance equal to or just smaller than the thinnest possible substrate to assure that contact is always maintained between the conveyor belts 170 and the substrate 104B. In this configuration, it is generally desirable to use a conveyor belt 170 that is formed from a compliant material, such as polyurethane foam. This conveyor assembly configuration may be useful to minimize particle generation and/or the possibility of damaging fragile substrates by preventing the substrate from shifting its position between the conveyor assemblies 110A and 110B during the inversion process.

In yet another embodiment, the gap “G” formed between the conveyor assemblies 110A and 110B is adjustable during one or more parts of the inversion process (e.g., loading, inversion, unloading) by allowing at least one of the conveyor assemblies 110A, 110B to be moved relative to the other conveyor assembly 110B, 110A. In one embodiment, a gap adjusting actuator 178 (e.g., linear motor, air cylinder) is coupled to the support components (e.g., support plates 151 and 159) in at least one of the conveyor assemblies 110A and 110B, and is thus configured to provide relative motion between the conveyor assemblies 110A and 110B to adjust the gap “G” formed there between. This configuration may be useful to minimize particle generation and/or the possibility of damaging the fragile substrate by bringing the conveyor assemblies into positive contact with the substrate during one or more parts of the inversion process. In another embodiment, the adjustable gap configuration is useful to facilitate one or more portions of the cleaning process discussed above in conjunction with FIGS. 13A and 13B.

While the foregoing is directed to embodiments of the present invention, other and further embodiments of the invention may be devised without departing from the basic scope thereof, and the scope thereof is determined by the claims that follow.

1. An apparatus for inverting substrates, comprising:
a first conveyor assembly having a first supporting surface and a first belt disposed over the first supporting surface;
a second conveyor assembly having a second supporting surface and a second belt disposed over the second supporting surface, wherein the first supporting surface is adjacently positioned over the second supporting surface to form a gap;
at least one first actuator coupled to the first belt so that the first belt can be positioned relative to the first supporting surface;
at least one second actuator coupled to the second belt so that the second belt can be positioned relative to the second supporting surface; and
an inversion actuator that is coupled to the first conveyor assembly and the second conveyor assembly and is adapted to orient the first supporting surface in the first conveyor assembly and the second supporting surface in the second conveyor assembly in either a face-up or face down orientation.

2. The apparatus of claim 1, further comprising:
a fluid source; and
the first supporting surface and the second supporting surface each further comprise a plurality of ports formed in a surface, wherein the fluid source is in fluid communication with the first belt or the second belt through the plurality of ports.

3. The apparatus of claim 2, wherein the first belt or the second belt comprises a porous material that allows a gas to flow from one side to an opposing side of the first belt or the second belt.

4. The apparatus of claim 1, further comprising an integrated conveyor belt cleaning system, comprising:
a fluid source;
a cleaning device having one or more ports that are positioned to direct a fluid delivered from the fluid source to a surface of the first belt or the second belt.

5. A method for inverting substrates, comprising:
positioning a substrate having a surface in a face-down orientation on a system conveyor;
transferring the substrate from the system conveyor to a first surface of a porous belt found in a first conveyor assembly;
restraining the surface of the substrate against the first surface of the porous belt by applying a vacuum to a second surface of the porous belt;
reorienting the surface of the substrate in a face-up orientation by rotating the first conveyor assembly; and
disposing the substrate on a first surface of a porous belt found in a second conveyor assembly after reorienting the substrate.

6. A method of claim 5, wherein transferring the substrate further comprises adjusting the velocity of the porous belt to match the velocity of the substrate when it first contacts the first surface of the porous belt.

7. A method of claim 5, further comprising adjusting a gap formed between the porous belt found in a first conveyor assembly and the porous belt found in a second conveyor assembly.

8. A method for inverting substrates, comprising:
positioning a substrate having a first substrate surface in a face-down orientation in a gap formed between a first conveyor assembly and a second conveyor assembly, wherein the first substrate surface is in contact with a first surface of a belt contained in the first conveyor assembly when it is positioned in the gap;
reorienting the first conveyor assembly and the substrate so that the first substrate surface is in a face-up orientation; and
disposing the substrate on a first surface of a belt in the second conveyor assembly after reorienting the substrate.

9. A method of claim 8, further comprising restraining the surface of the substrate against the first surface of the belt in the first conveyor assembly by applying a vacuum to a second surface of the belt before reorienting the first conveyor assembly.

10. A method of claim 8, further comprising adjusting the gap formed between the first conveyor assembly and the second conveyor assembly after positioning the substrate in the gap.

11. A method of claim 8, wherein the first substrate surface is in contact with a first surface of the belt contained in the first conveyor assembly and a second substrate surface is in contact with the first surface of the belt contained in the second conveyor assembly when the substrate is positioned in the gap.

12. A method of claim 11, further comprising:
restraining the surface of the substrate against the first surface of the belt in the first conveyor assembly by applying a vacuum to a second surface of the belt; and
cleaning a surface of the substrate by moving the belt in the second conveyor assembly relative to the belt contained in the first conveyor assembly.

13. A method of claim 8, further comprising transferring the substrate from a position between the first conveyor assembly and the second conveyor assembly by moving the belt contained in the first conveyor assembly and the belt contained in the second conveyor assembly at substantially the same relative velocity.

14. A method of claim 8, wherein a path that the substrate moves along when it is positioned within the gap is parallel to a first transfer direction, and the rotational axis about which the substrate is rotated when the substrate is reoriented is also parallel to the first transfer direction.

15. A method of claim 8, wherein a path that the substrate moves along when it is positioned within the gap is parallel to a first transfer direction, and the rotational axis about which the substrate is rotated when the substrate is reoriented substantially coincides with a centerline of the substrate and is perpendicular to the first transfer direction.
